(19) United States
(12) Patent Application Publication
(10) Pub. No.: US 2011/0302004 A1
(43) Pub. Date: Dec. 8, 2011

(54) CUSTOMIZING WORKFLOW BASED ON PARTICIPANT HISTORY AND PARTICIPANT PROFILE

(75) Inventors: Todd E. Johnson, Chatfield, MN (US); John E. Petri, St. Charles, MN (US)

(73) Assignee: INTERNATIONAL BUSINESS MACHINES CORPORATION, Armonk, NY (US)

(21) Appl. No.: 12/793,304

(22) Filed: Jun. 3, 2010

(51) Int. Cl. G06Q 10/00

(52) U.S. Cl. 705/7.42

(57) ABSTRACT

A workflow system allows determining at least one date based on various factors including the complexity of a task, a participant's history as monitored by the workflow system, and a participant's profile as entered by the participant. In addition, the workflow system generates customized notifications according to the participant's reliability in meeting due dates in the past and a notification preference specified by the participant. The result is a powerful and flexible workflow system. The dates determined by the workflow system may include one or more due dates for tasks and one or more dates for notifications to participants.

### BACKGROUND

1. Technical Field

This disclosure generally relates to workflow systems, and more specifically relates to customizing workflow dates based on history of the participant as tracked by the workflow system and profile of the participant entered by the participant.

2. Background Art

A content management system (CMS) allows many users to efficiently share electronic content such as text, audio files, video files, pictures, graphics, etc. Content management systems typically control access to content in a repository. A user may generate content, and when the content is checked into the repository, the content may be subsequently processed by the CMS according to predefined rules. A user may also check out content from the repository, or link to content in the repository while generating content. The rules in a CMS assure that content that comes into or out of the system or that is linked to meets desired criteria specified in the rules.

Many content management systems include a workflow system for managing workflow performed by participants that use the content management system. For example, a workflow could be defined for a particular document that assigns different tasks for the document to many different participants. A workflow coordinator manually sets due dates for the different participates to perform their assigned tasks. However, the setting of due dates by the workflow coordinator can be error-prone if the workflow coordinator is unaware of all the factors affecting the due dates, such as the complexity of the task or the availability of the participants. An integral function of workflow systems is the tracking of the due dates for the various tasks. Known workflow systems define a single notification default that is used for all participants. However, experience has shown that different participants to the workflow may perform much differently. For example, one participant may make his or her deadlines 95% of the time, while a different participant may make his or her deadlines only 10% of the time. Providing frequent notification of tasks due will be annoying to the participant who makes deadlines 95% of the time. Less frequent notification of tasks due may not be effective to remind the participant who makes deadlines only 10% of the time. As a result, known workflow systems provide an inflexible single default notification that will be applied to all participants that does not account for the history or preference of a participant.

### BRIEF SUMMARY

A workflow system allows determining at least one date based on various factors including the complexity of a task, a participant's history as monitored by the workflow system, and a participant's profile as entered by the participant. In addition, the workflow system generates customized notifications according to the participant's reliability in meeting due dates in the past and a notification preference specified by the participant. The result is a powerful and flexible workflow system. The dates determined by the workflow system may include one or more due dates for tasks and one or more dates for notifications to participants.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a networked computer system that includes a server computer system that has a content management system with a workflow system;

FIG. 2 is a block diagram showing aspects of the workflow system shown in FIG. 1;

FIG. 3 is a block diagram showing aspects of the workflow system shown in FIGS. 1 and 2;

FIG. 4 is a sample participant history determined by the workflow system;

FIG. 5 is a sample participant profile for the workflow system with data entered by the participant;

FIG. 6 shows sample complexity of documents;

FIG. 7 is a flow diagram of a method for adjusting due date for a task for a participant in the workflow system;

FIG. 8 is pseudo-code showing one specific implementation for method 700 in FIG. 7;

FIG. 9 is a flow diagram of a method for generating customized notifications based on a participant's history and notification preference; and

FIG. 10 is pseudo-code showing one specific implementation for method 900 in FIG. 9.

### DETAILED DESCRIPTION

Many known content management systems use extensible markup language (XML) due to its flexibility and power in managing diverse and different types of content. One known content management system that uses XML is Solution for Compliance in a Regulated Environment (SCORE) developed by IBM Corporation. XML is growing in popularity, and is quickly becoming the preferred format for authoring and publishing. While XML documents are one possible example of content that may be managed by a content management system, the disclosure and claims herein expressly extend to content management systems that do not use XML.

The claims and disclosure herein provide a way to for a workflow system to determine at least one date based on various factors including the complexity of a task, a participant's history as monitored by the workflow system, and a participant's profile as entered by the participant. In addition, the workflow system generates customized notifications according to the participant's reliability in meeting due dates in the past and a notification preference specified by the participant. The result is a powerful and flexible workflow system. The dates determined by the workflow system may include one or more due dates for tasks and one or more dates for notifications to participants.

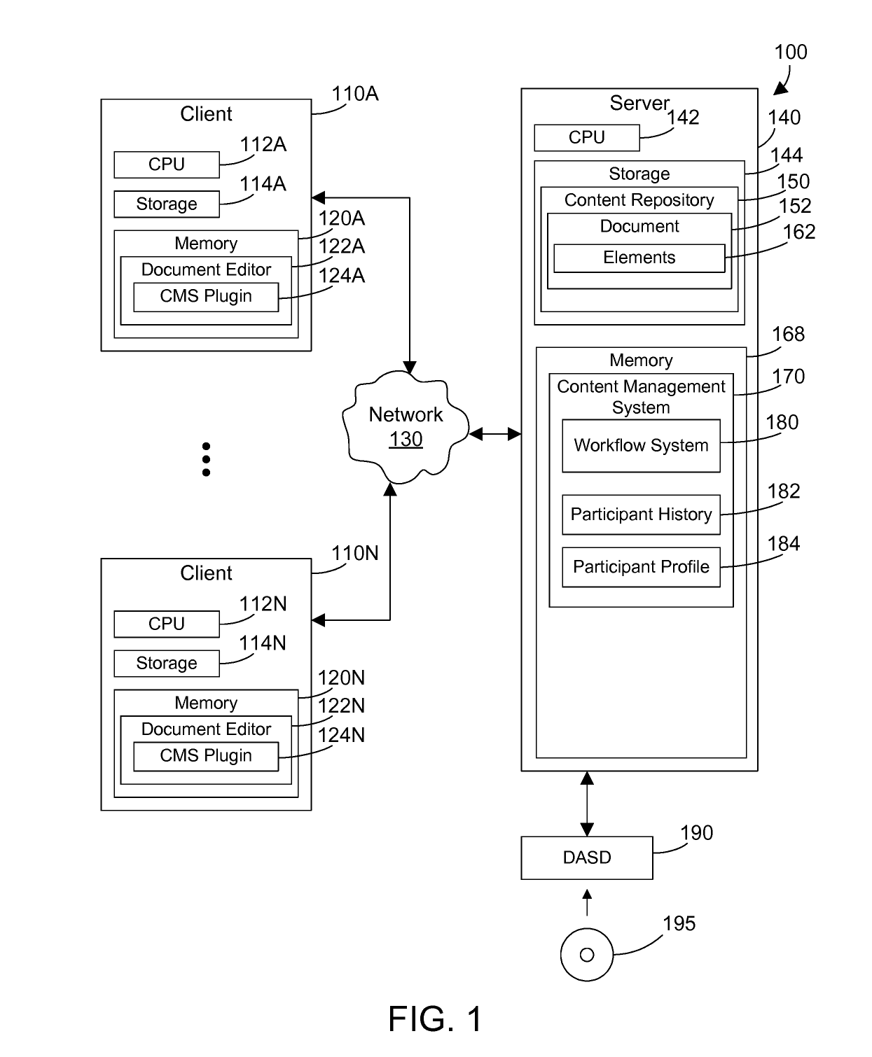

Referring to FIG. 1, networked computer system 100 includes multiple clients, shown in FIG. 1 as clients 110A, . . . , 110N, coupled to a network 130. Each client preferably includes a CPU, storage, and memory that contains a document editor, and a content management system (CMS) plugin. Thus, client 110A includes a CPU 112A, storage 114A, memory 120A, a document editor 122A in the memory 120A that is executed by the CPU 112A, and a CMS plugin 124A that allows the document editor 122A to interact with content 152 in the repository 150 that is managed by the CMS 170 in server 140. In similar fashion, other clients have similar components shown in client 110A, through client 110N, which includes a CPU 112N, storage 114N, memory 120N, a document editor 122N, and a CMS plugin 124N.

The CMS 170 resides in the main memory 168 of a server computer system 140 that also includes a CPU 142 and storage 144 that includes a content repository 150 that holds one or more documents 152 managed by the CMS 170. Document 152 may include one or more elements 162. The term “element” means any section or portion of a document that may be individually displayed or operated on, whether actually in the document or linked to the document.

One example of a suitable server computer system 140 is an IBM eServer System i computer system. However, those skilled in the art will appreciate that the disclosure herein applies equally to any type of client or server computer systems, regardless of whether each computer system is a complicated multi-user computing apparatus, a single user workstation, or an embedded control system. CMS 170 includes a workflow system 180, participant history 182 and participant profile 184. The workflow system 180 allows a workflow coordinator to define a workflow that includes multiple tasks, including which participants will participate in the workflow, and due dates for the tasks in the workflow. Details of workflow system 180 are shown in more detail and discussed below with reference to the remaining figures.

The participant history 182 is generated by the workflow system 180, and includes any suitable information relating to the participant's performance in using the workflow system 180. For example, the participant history 182 could indicate a percentage of time the participant completes tasks assigned by the workflow system 180 on time. The participant history 182 could also indicate how many tasks are pending and an estimate of how long it will take to complete those tasks. Of course, participant history 182 could also include any other suitable information that could be collected by the workflow system 180 relating to a participant. The participant profile 184 is information entered by a participant that may be used by the workflow system 180. For example, participant profile 184 could indicate work schedule for a participant and notification preference for the participant. Of course, participant profile 184 could additionally include any information pertaining to a participant that the participant may want to make available for the workflow system that could help the workflow system to perform its tasks.

In FIG. 1, repository 150 is shown separate from content management system 170. In the alternative, repository 150 could be within the content management system 170. Regardless of the location of the repository 150, the content management system 170 controls access to content 152 in the repository 150.

Server computer system 140 may include other features of computer systems that are not shown in FIG. 1 but are well-known in the art. For example, server computer system 140 preferably includes a display interface, a network interface, and a mass storage interface to an external direct access storage device (DASD) 190. The display interface is used to directly connect one or more displays to server computer system 140. These displays, which may be non-intelligent (i.e., dumb) terminals or fully programmable workstations, are used to provide system administrators and users the ability to communicate with server computer system 140. Note, however, that while a display interface is provided to support communication with one or more displays, server computer system 140 does not necessarily require a display, because all needed interaction with users and other processes may occur via the network interface.

The network interface is used to connect the server computer system 140 to multiple other computer systems (e.g., 110A, . . . , 110N) via a network, such as network 130. The network interface and network 130 broadly represent any suitable way to interconnect electronic devices, regardless of whether the network 130 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

The mass storage interface is used to connect mass storage devices, such as a direct access storage device 190, to server computer system 140. One specific type of direct access storage device 190 is a readable and writable CD-RW drive, which may store data to and read data from a CD-RW 195.

Main memory 168 preferably contains data and an operating system that are not shown in FIG. 1. A suitable operating system is a multitasking operating system known in the industry as i5/OS; however, those skilled in the art will appreciate that the spirit and scope of this disclosure is not limited to any one operating system. In addition, server computer system 140 utilizes well known virtual addressing mechanisms that allow the programs of server computer system 140 to behave as if they only have access to a large, single storage entity instead of access to multiple, smaller storage entities such as main memory 168, storage 144 and DASD device 190. Therefore, while data, the operating system, and content management system 170 may reside in main memory 168, those skilled in the art will recognize that these items are not necessarily all completely contained in main memory 168 at the same time. It should also be noted that the term “memory” is used herein generically to refer to the entire virtual memory of server computer system 140, and may include the virtual memory of other computer systems coupled to computer system 140.

CPU 142 may be constructed from one or more microprocessors and/or integrated circuits. CPU 142 executes program instructions stored in main memory 168. Main memory 168 stores programs and data that CPU 142 may access. When computer system 140 starts up, CPU 142 initially executes the program instructions that make up the operating system.

Although server computer system 140 is shown to contain only a single CPU, those skilled in the art will appreciate that a content management system 170 may be practiced using a computer system that has multiple CPUs. In addition, the interfaces that are included in server computer system 140 (e.g., display interface, network interface, and DASD interface) preferably each include separate, fully programmed microprocessors that are used to off-load compute-intensive processing from CPU 142. However, those skilled in the art will appreciate that these functions may be performed using I/O adapters as well.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

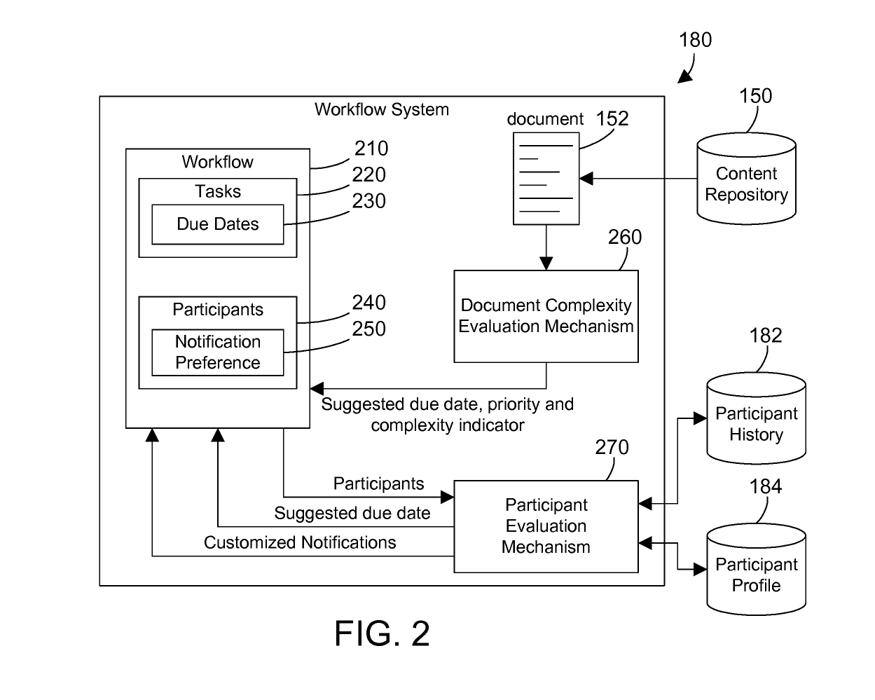

FIG. 2 shows additional details of the workflow system 180 shown in FIG. 1. The workflow system 180 allows a workflow coordinator to define a workflow 210 that includes multiple tasks 220 with respective due dates 230 for each task. The workflow coordinator assigns each task 220 to a participant 240. Each participant 240 may optionally specify a notification preference 250.

We assume for the example in FIG. 2 the workflow system 180 is part of a content management system 170 as shown in FIG. 1, and the workflow 210 relates to the creation of an instance of document 152 in the content repository 150. The workflow coordinator will thus select document 152, and the workflow 210 defined by the workflow coordinator will reflect steps in generating the instance of document 152. The workflow system 180 includes a document complexity evaluation mechanism 260 that analyzes document 152 and determines the complexity of document 152. Note the complexity can be indicated in any suitable way. For example, three complexity levels could be defined, namely high, medium and low. The document complexity evaluation mechanism 260 could evaluate the document 152 and determine whether the document is high complexity, medium complexity, or low complexity based on one or more criteria. Of course, any other suitable method for indicating complexity could also be used, including a numerical scale. In addition, any suitable criteria could be used to assign a complexity indicator to a document. The disclosure and claims herein extend to any suitable way to evaluate a document or workflow task and assign a corresponding complexity indicator.

The document complexity evaluation mechanism 260 may output to the workflow 210 a suggested due date, a priority, and the complexity indicator. The suggested due date may be determined by evaluating numerous factors discussed in more detail below. The priority may be assigned based on the desired due date assigned by the workflow coordinator and based on the complexity of a task or document. Thus, a task on a document that has a high complexity indicator may take longer for a participant to perform, which could result in the priority of the task being set higher than other pending tasks even though the due date is farther away to assure the participant gets the task done on time.

A participant evaluation mechanism 270 monitors the participant history 182 and participant profile 184 for the participants in the workflow, and uses this information to generate a suggested due date for the various tasks and customized notifications for the participants. The participant history 182 is information gathered by the workflow system 180 that relates to the performance of a particular participant. For example, participant history 182 could indicate how effective the participant has been in the past at meeting due dates, and could also include the participant's current workload and estimated time to complete the current workload. The participant profile 184 is information entered by the participant, and may include work schedule information and a notification preference. The participant evaluation mechanism 270 analyzes the data in the participant history 182 and participant profile 184 to determine appropriate dates for the workflow 210, which include due dates and dates for custom notifications to the participant.

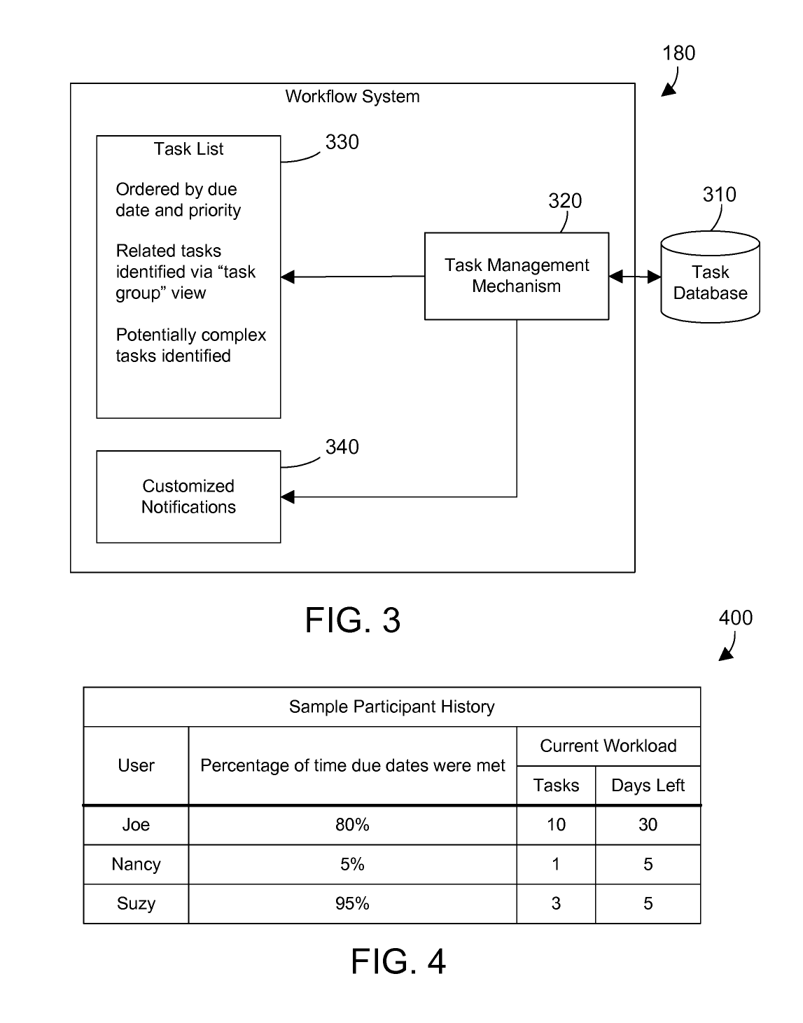

Additional details of the workflow system 180 are shown in FIG. 3 when the workflow system 180 interacts with a participant in the workflow. The workflow system 180 references a task database 310, which includes the tasks 220 in FIG. 2 that are defined for a workflow 210. A task management mechanism 320 reads the task database 310, and displays a task list 330 to the participant. The task list 330 is preferably ordered by due date and priority. In addition, related tasks may be identified to the participant via a “task group” view. The task group view allows a participant to see similar tasks even though they may have varied due dates. A participant may gain efficiencies by performing similar tasks at one time. The task group view displays to the participant which tasks are similar within some defined criteria. In addition, the task list 330 may identify potentially complex tasks so the participant knows which tasks are complex, and will therefore take more time to complete. The identification of complex tasks may be done in any suitable manner, including without limitation bolding, highlighting, increased font size, adding in icon to the display, etc.

The task management system 320 will also dispatch one or more customized notifications 340 to a workflow participant. Note the customized notifications 340 preferably include notifications that are generated from the participant history 182 and participant profile 184. Examples of customized notifications are provided below.

FIG. 4 shows a sample participant history 400 for three users (or participants) of the workflow system 180. Sample participant history 400 is one suitable example for participant history 182 shown in FIGS. 1 and 2. Note the information in the sample participant history 400 is generated by the workflow system 180 monitoring the participant's use of the workflow system 180, and therefore cannot be manually changed by the participant. The sample participant history 400 in FIG. 4 shows the user Joe met due dates 80% of the time, and has a current workload of 10 tasks that will take 30 days to complete. The user Nancy met due dates only 5% of the time, and has a current workload of one task that will take five days to complete. The user Suzy met due dates 95% of the time and has a current workload of three tasks that will take five days to complete. The participant evaluation mechanism 270 could read the sample participant history 400 and provide a suggested due date for a task based on the participant's workload, and can further provide customized notifications based on the percentage of time the user met his or her due dates. This allows more notifications for those who have not met a high percentage of their due dates in the past while providing fewer notifications for those who have met a high percentage of their due dates in the past.

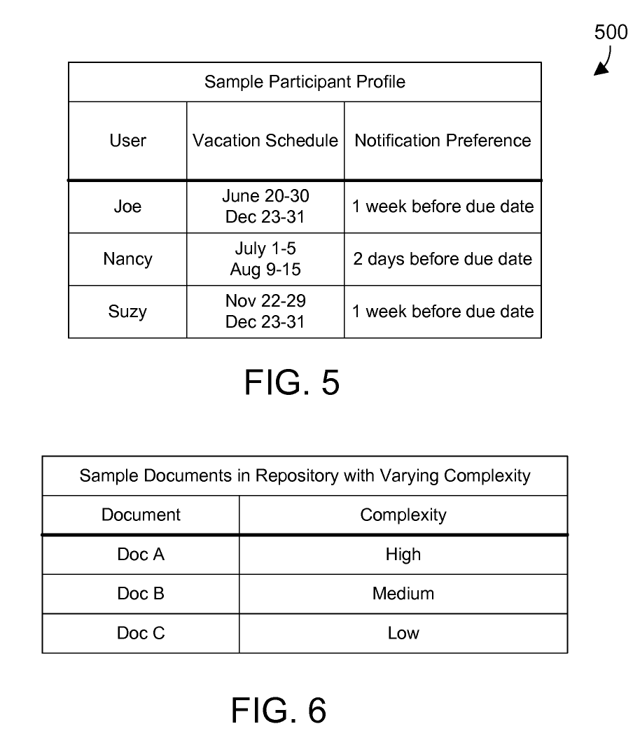

FIG. 5 shows a sample participant profile 500. The sample participant profile 500 is one suitable example of participant profile 184 shown in FIGS. 1 and 2. Sample participant profile 500 includes data entered by a participant, which can then be taken into account by the workflow system 180 in determining dates for due dates and notifications. Sample participant profile 500 includes a column for vacation schedule and a column for notification preference. Note the vacation schedule column is a representation of a work schedule, because it is assumed the participant will be available on normal workdays other than the vacation days listed. User Joe has days of vacation specified, and has a notification preference of 1 week before the due date. User Nancy has days of vacation specified, and has a notification preference of 2 days before the due date. User Suzy has days of vacation scheduled, and has a notification preference of 1 week before the deadline. The work schedule (or vacation schedule shown in FIG. 5) allows the participant evaluation mechanism 270 in FIG. 2 to see whether the participant will be on vacation during the workflow, which could affect the due date for one or more tasks. In addition, the participant evaluation mechanism 270 may also see from the current workload in FIG. 4 whether the participant is too busy to meet a desired due date. The workflow system 180 may take into account the current workload and work schedule of a participant to determine whether an adjustment to the due date is needed. In the alternative, if a participant's current workload or work schedule will not allow the participant to meet a desired due date, the workflow system 180 could specify a substitute participant that is able to meet the desired due date.

FIG. 6 shows three sample documents in repository 150 in FIGS. 1 and 2, along with a corresponding complexity indicator. For this example, we assume Doc A has a complexity indicator of High, Doc B has a complexity indicator of Medium, and Doc C has a complexity indicator of Low. The complexity of the documents is preferably determined by the document complexity evaluation mechanism 260 in FIG. 2. The workflow system 180 may take a document's complexity into account when determining a due date for a task in the workflow 210. Thus, documents with a complexity indicator of High or Medium may require the desired due date entered by the workflow coordinator to be adjusted to give more time due to the complexity of the document being generated.

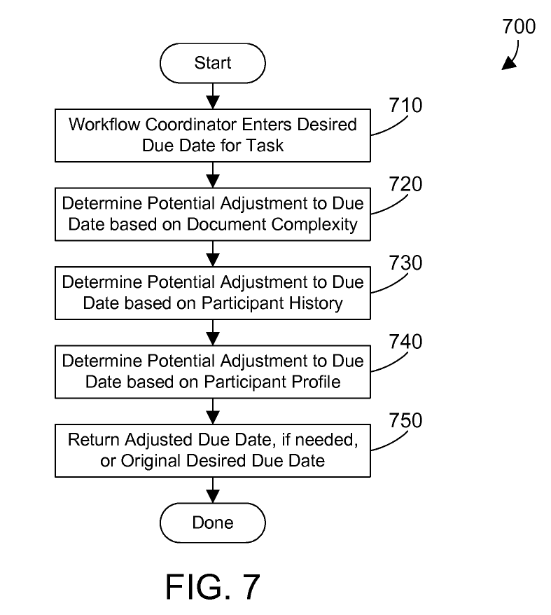

Referring to FIG. 7, a method 700 includes steps preferably performed by the workflow system 180 in FIGS. 1-3. First, the workflow coordinator that is working to define a workflow 210 enters a desired due date for a task (step 710). The workflow system 180 then determines a potential adjustment to the due date based on the document complexity (step 720). For example, if the document has a complexity indicator of High, the due date may be adjusted to provide a minimum of three weeks to accomplish the task. If the document has a complexity indicator of Medium, the due date may be adjusted to provide a minimum of two weeks to accomplish the task. The workflow system 180 then determines a potential adjustment to the due date based on the participant history (step 730). The participant history 182 in FIGS. 1 and 2 and 400 in FIG. 4 include data generated by the workflow system 180 in response to the workflow system monitoring how participants have used the workflow system 180 in the past. Participant history may include a measure of the participant's reliability based on the percentage of due dates the participant met in the past. The participant history 182 may also include the current workload of each participant, which is determined by the workflow system 180. Thus, with the data in FIG. 4, if Joe is necessary to the workflow but his current workload will not allow him to work on the new task for 30 days, the due date may need to be adjusted to reflect Joe's workload. In the alternative, the new task could be given a higher priority than one or more of the ten existing tasks that Joe has to perform. The workflow system 180 also determines a potential adjustment to the due date based on the participant profile (step 740). The participant profile 184 in FIGS. 1 and 2 and 500 in FIG. 5 include data entered by the participant, such as work schedule and a notification preference. If the participant is going to be on vacation and will not have sufficient time to perform the task, the due date could be adjusted to accommodate the participant's work schedule. The adjusted due date is then returned (step 750). If no adjustments were made to the due date in step 720-740, the original due date is returned in step 750. Method 700 is then done.

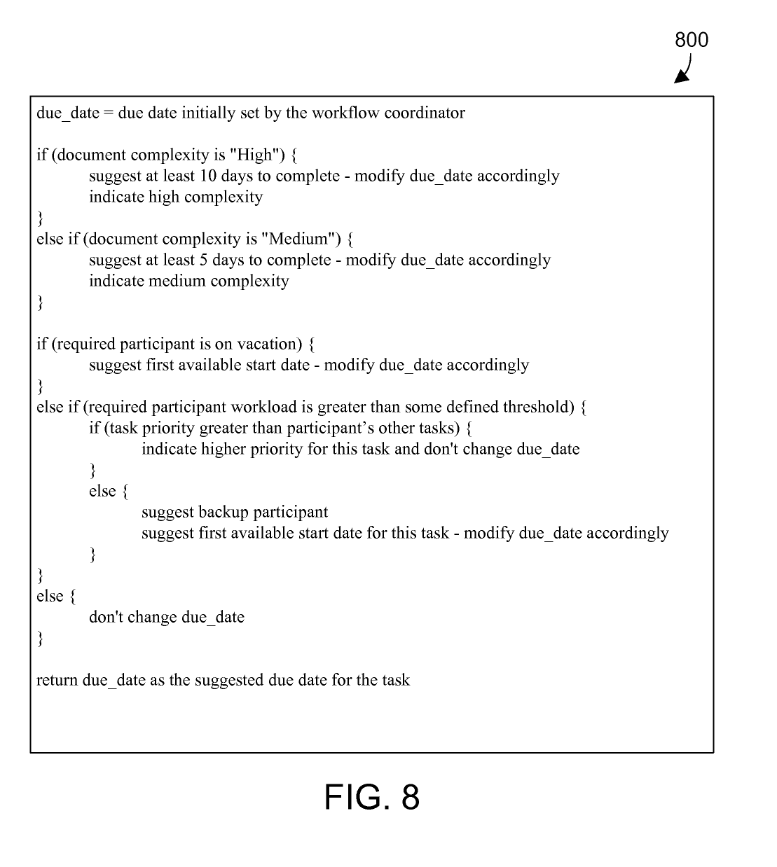

FIG. 8 shows pseudo-code of one specific example for adjusting a due date initially set by the workflow coordinator in accordance with method 700 in FIG. 7. If the document has a complexity of High, the workflow system could suggest providing at least 10 days to complete the task, and modify the due date accordingly, and could return a complexity indicator of High for the document. If the document has a complexity of Medium, the workflow system could suggest providing at least 5 days to complete the task, and modify the due date accordingly, and could return a complexity indicator of Medium for the document. If the required participant is on vacation, the workflow system suggests a start date that accounts for the required participant's work schedule, and modifies the due date accordingly. If the required participant's workload is greater than some defined threshold, and if the task has priority greater than the participant's other tasks, the priority for this task will be set to higher priority and the due date is not changed. If the task does not have priority greater than the participant's other tasks, the workflow system could suggest a backup participant, and suggest a first available start date for this task based on the history and profile for the backup participant. If the required participant workload is less than or equal to the defined threshold, the due date is not changed because the required participant should be able to complete the task by the due date. The due date is then returned as the suggested due date for the task. Note the due date returned could be adjusted or could be the original due date entered by the workflow coordinator. In the most preferred implementation, the workflow coordinator has discretion regarding whether or not to accept the suggested due date, and may decide to ignore the suggestion and keep the original desired due date.

Another feature of the workflow system 180 is the ability to provide customized notifications. Prior art workflow system provide the same notification to each participant. Thus, if the workflow coordinator specifies to notify the participants a week in advance of a due date, the workflow system will notify all participants a week before the due date. The customized notifications herein provide notifications that will help each participant complete their work on time without undue annoyance from notifications that are not needed.

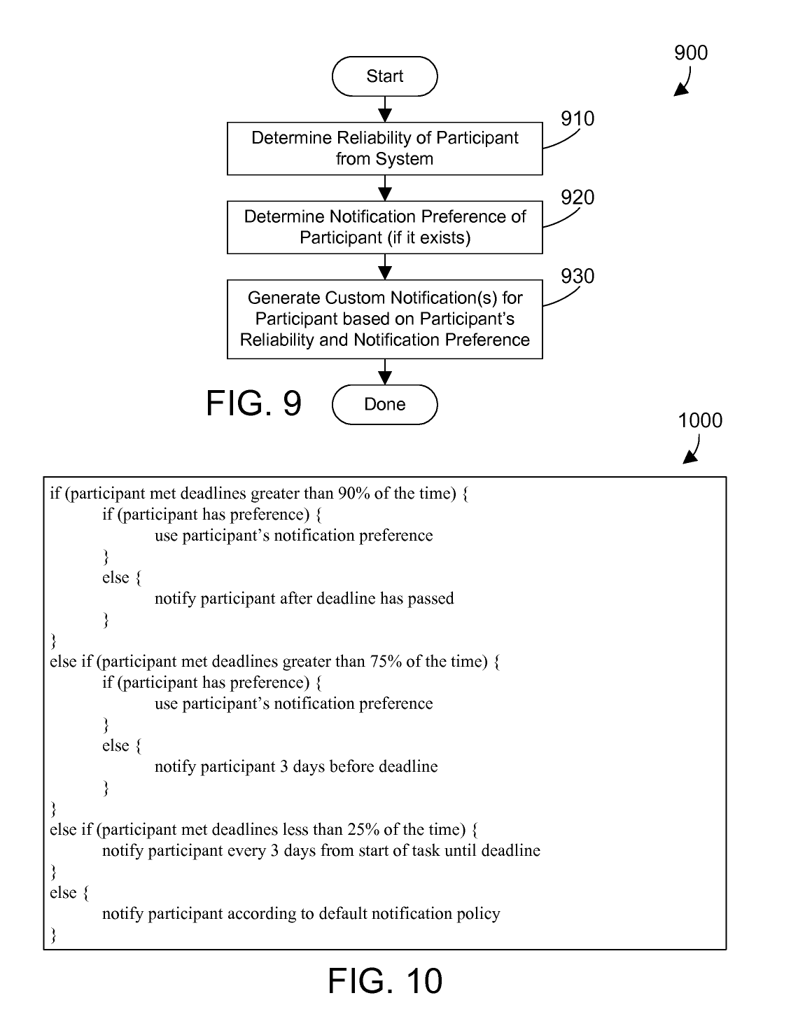

Referring to FIG. 9, a method 900 begins by determining the reliability of a participant from the workflow system (step 910). For the specific participant history 400 shown in FIG. 4, the reliability is indicated by the percentage of time the participant met their past due dates. The notification preference, if it has been specified by the participant, is also determined (step 920). A notification preference is shown as 250 in FIG. 2 and in the last column of FIG. 5. Custom notifications are then generated by the workflow system based on the participant's reliability determined by the workflow system and based on the participant's preference specified by the participant (step 930). Method 900 is then done. Providing customized notifications according to the participant's reliability and notification preference allows the workflow system to provide more notifications to those participants whose reliability in meeting due dates in the past is not very high while providing fewer notifications to those participants whose reliability in meeting due dates in the past is much better.

FIG. 10 shows pseudo-code 1000 for the workflow system to generate customized notifications according to method 900 shown in FIG. 9. If the participant met due dates more than 90% of the time in the past, and if the participant has a preference, the participant's notification preference is used to generate a customized notification for that participant. In addition, a notification is also sent after the due date has passed if the participant did not meet the due date. If the participant met due dates more than 75% of the time in the past, and if the participant has a preference, the participant's notification preference is used to generate a customized notification for that participant. In addition, a notification is also sent 3 day before the due date. If the participant met due dates less than 25% of the time in the past, the workflow system notifies the participant every three days from the start of the task to until the due date. If the participant met due dates between 25% of the time and 75% of the time, the participant is notified according to a default notification policy. We assume the workflow coordinator defines the default notification policy. For example, a suitable default notification policy could specify to notify the participant a week before the due date and three days before the due date, then again after the due date has passed if the participant has not finished the task.

The workflow system described herein and claimed allows adjusting a due date based on many factors including the complexity of a task, a participant's history as monitored by the workflow system, and a participant's profile as entered by the participant. In addition, the workflow system generates customized notifications according to the participant's reliability in meeting due dates in the past and a notification preference specified by the participant. The result is a powerful and flexible workflow system. The workflow system determines at least one date, which may include one or more due dates for tasks and one or more dates for customized notifications.

The specific examples shown in the figures and discussed above are in the context of a workflow system in a content management system. However, the disclosure and claims herein expressly extend to any workflow system, whether integrated as part of a different system or implemented as a stand-alone workflow system.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a workflow system residing in the memory and executed by the at least one processor, the workflow system operating on a workflow that comprises a plurality of tasks assigned to a plurality of participants, the workflow system determining history for a selected participant comprising past performance for the selected participant as monitored by the workflow system and determining a profile for the selected participant entered by the selected participant, the workflow system determining at least one date for the workflow from the history for the selected participant and the profile for the selected participant.

2. The apparatus of claim 1 wherein the history for the selected participant indicates how often the selected participant completed past tasks assigned by the workflow system by due dates corresponding to the past tasks, and current workload of the selected participant.

3. The apparatus of claim 1 wherein the profile for the selected participant comprises work schedule and notification preference.

4. The apparatus of claim 1 wherein the at least one date comprises a due date for a task in the workflow for the selected participant.

5. The apparatus of claim 1 wherein the at least one date comprises a notification date for the selected participant.

6. The apparatus of claim 1 wherein the workflow system comprises a complexity evaluation mechanism that evaluates inputs to the workflow and outputs a complexity indicator for each of the inputs, wherein the workflow system further determines the at least one date from the complexity indicator for an input operated on by the workflow system.

7. The apparatus of claim 1 wherein the workflow system generates at least one customized notification for the selected participant based on a due date entered by a workflow coordinator and based on the history for the selected participant and the profile for the selected participant.

8. The apparatus of claim 1 wherein the workflow system provides a view of related tasks to the selected participant with an indication of complexity of each related task.

9. A computer-implemented method for processing a workflow that comprises a plurality of tasks assigned to a plurality of participants, the method comprising the steps of:
determining history for a selected participant comprising past performance for the selected participant as monitored by the workflow system;
determining a profile for the selected participant entered by the selected participant; and
determining at least one date for the workflow from the history for the selected participant and the profile for the selected participant.

10. The method of claim 9 wherein the history for the selected participant indicates how often the selected participant completed past tasks assigned by the workflow system by due dates corresponding to the past tasks, and current workload of the selected participant.

11. The method of claim 9 wherein the profile for the selected participant comprises work schedule and notification preference.

12. The method of claim 9 wherein the at least one date comprises a due date for a task in the workflow for the selected participant.

13. The method of claim 9 wherein the at least one date comprises a notification date for the selected participant.

14. The method of claim 9 further comprising the steps of:
evaluating inputs to the workflow; and
outputting a complexity indicator for each of the inputs;
wherein the step of determining the at least one date for the workflow comprises the step of considering the complexity indicator for an input.

15. The method of claim 9 further comprising the step of generating at least one customized notification for the selected participant based on a due date entered by a workflow coordinator and based on the history for the selected participant and the profile for the selected participant.

16. The method of claim 9 further comprising the step of providing a view of related tasks to the selected participant with an indication of complexity of each related task.

17. A computer-implemented method for processing a workflow that comprises a plurality of tasks assigned to a plurality of participants, the method comprising the steps of:
receiving an input due date from a workflow coordinator who defines a selected task in the workflow;
determining a first potential adjustment to the input due date based on complexity of the selected task;
determining a second potential adjustment to the input due date based on history for a selected participant comprising past performance for the selected participant as monitored by a workflow system that processes the workflow, wherein the history for the selected participant indicates how often the selected participant completes tasks assigned by the workflow system by due dates corresponding to the tasks and current workload of the selected participant;
determining a third potential adjustment to the input due date based on a profile for the selected participant entered by the selected participant that comprises work schedule and notification preference;
generating a suggested due date for the selected task in the workflow for the selected participant based on the input due date and the first, second and third potential adjustments to the input due date;
generating a priority for the selected task in the workflow for the selected participant based on the suggested due date, the history for the selected participant and the profile for the selected participant; and
generating a plurality of customized notifications for the selected participant based on the how often the selected participant completes tasks assigned by the workflow system and based on the notification preference entered by the selected participant.

18. An article of manufacture comprising software stored on a computer-readable storage medium, the software comprising:
a workflow system operating on a workflow that comprises a plurality of tasks assigned to a plurality of participants, the workflow system determining history for a selected participant comprising past performance for the selected participant as monitored by the workflow system and determining a profile for the selected participant entered by the selected participant, the workflow system determining at least one date for the workflow from the history for the selected participant and the profile for the selected participant.

19. The article of manufacture of claim 18 wherein the history for the selected participant indicates how often the selected participant completed past tasks assigned by the workflow system by due dates corresponding to the past tasks, and current workload of the selected participant.

20. The article of manufacture of claim 18 wherein the profile for the selected participant comprises work schedule and notification preference.

21. The article of manufacture of claim 18 wherein the at least one date comprises a due date for a task in the workflow for the selected participant.

22. The article of manufacture of claim 18 wherein the at least one date comprises a notification date for the selected participant.

23. The article of manufacture of claim 18 wherein the workflow system comprises a complexity evaluation mechanism that evaluates inputs to the workflow and outputs a complexity indicator for each of the inputs, wherein the workflow system further determines the at least one date from the complexity indicator for an input operated on by the workflow system.

24. The article of manufacture of claim 18 wherein the workflow system generates at least one customized notification for the selected participant based on a due date entered by a workflow coordinator and based on the history for the selected participant and the profile for the selected participant.

25. The article of manufacture of claim 18 wherein the workflow system provides a view of related tasks to the selected participant with an indication of complexity of each related task.
